(19) United States
(12) Patent Application Publication
(10) Pub. No.: US 2026/0138602 A1
(43) Pub. Date: May 21, 2026

(54) TRAVEL CONTROLLER

(71) Applicant: SUBARU CORPORATION, Tokyo (JP)

(72) Inventor: Kazuki KITTA, Tokyo (JP)

(21) Appl. No.: 19/372,593

(22) Filed: Oct. 29, 2025

(30) Foreign Application Priority Data
Nov. 19, 2024 (JP) 2024-201738

(51) Int. Cl. B60W 30/12; B62D 15/02

(52) U.S. Cl. CPC B60W 30/12; B62D 15/025; B60W 2510/202; B60W 2540/229; B60W 2552/30; B60W 2710/202

(57) ABSTRACT

A travel controller includes a determiner, a curvature detector, a steering torque detector, an assistance torque setter, a first storage, and a controller. The assistance torque setter calculates one or both of a controlled variable to return a vehicle toward the middle of a lane and a controlled variable to avoid deviation of the vehicle, and sets assistance torque in accordance with the one or both of the controlled variables. The first storage holds map data in which a level of alertness of the driver determined by the determiner, a curvature of the lane detected by the curvature detector, and a first threshold value of the assistance torque are associated. The controller limits the one or both of the controlled variables at least when the steering torque becomes larger than the first threshold value, and afterward, allows the assistance torque setter to set the assistance torque.

### CROSS-REFERENCE TO RELATED APPLICATIONS

The present application claims priority from Japanese Patent Application No. 2024-201738 filed on November 19, 2024, the entire contents of which are hereby incorporated by reference.

### BACKGROUND

The disclosure relates to a travel controller.

A lane deviation prevention device has been known. The lane deviation prevention device recognizes a lane on which a vehicle is traveling, based on an image of travel environment frontward of the vehicle captured by a camera or the like. The lane deviation prevention device estimates, on each control cycle, a position of the vehicle after a predetermined time from that point of time. Upon predicting deviation of the vehicle from the recognized lane, the lane deviation prevention device actuates a steering actuator or a brake actuator to provide assistance in avoiding the deviation.

An example of a device of this kind has been disclosed in which a video camera or a sensor equal thereto detects a lane mark on a road, and an associated signal processor estimates a lateral position of a vehicle relative to the lane mark. The device assists a driver in applying steering torque to a steering mechanism or supplies the steering mechanism with a torque input opposing the steering torque, using an electric motor coupled to the steering mechanism. When the steering torque applied by the driver becomes larger than a predetermined torque threshold value, the device overrides, or cancels, an effect of the steering torque applied by the driver. For example, reference is made to Japanese Unexamined Patent Application Publication (JP-A) No. H07-104850.

### SUMMARY

An aspect of the disclosure provides a travel controller configured to be applied to a vehicle. The travel controller includes a determiner, a curvature detector, a steering torque detector, an assistance torque setter, a first storage, and a controller. The determiner is configured to determine a level of alertness of a driver who drives the vehicle. The curvature detector is configured to detect a curvature of a lane traveled by the vehicle, from a captured image of a frontward view of the vehicle. The steering torque detector is configured to detect steering torque given to a steering wheel of the vehicle by the driver. The assistance torque setter is configured to calculate one or both of a first controlled variable to return the vehicle toward the middle of the lane traveled by the vehicle and a second controlled variable to avoid deviation of the vehicle from the middle of the lane traveled by the vehicle, and set assistance torque to be applied to a steering mechanism of the vehicle in accordance with the one or both of the first controlled variable and the second controlled variable. The first storage is configured to hold map data in which the level of alertness of the driver, the curvature, and a first threshold value of the assistance torque are associated with each other. The controller is configured to limit the one or both of the first controlled variable and the second controlled variable at least when the steering torque becomes larger than the first threshold value, and afterward, make a control to allow the assistance torque setter to set the assistance torque.

An aspect of the disclosure provides a travel controller configured to be applied to a vehicle. The travel controller includes one or more processors and one or more memories communicably coupled to the one or more processors. The one or more processors are configured to: determine a level of alertness of a driver who drives the vehicle; detect a curvature of a lane traveled by the vehicle, from a captured image of a frontward view of the vehicle; detect steering torque given to a steering wheel of the vehicle by the driver; calculate one or both of a first controlled variable to return the vehicle toward the middle of the lane traveled by the vehicle and a second controlled variable to avoid deviation of the vehicle from the middle of the lane traveled by the vehicle, and set assistance torque to be applied to a steering mechanism of the vehicle in accordance with the one or both of the first controlled variable and the second controlled variable; and limit the one or both of the first controlled variable and the second controlled variable at least when the steering torque becomes larger than a first threshold value of the assistance torque, and afterward, make a control to set the assistance torque. The one or more memories are configured to hold map data in which the level of alertness of the driver, the curvature, and the first threshold value are associated with each other.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram of a configuration of a travel controller according to an embodiment of the disclosure.

FIG. 2 is a graph illustrating relation between assistance torque, an upper limit value of the assistance torque, and a steering torque value according to the embodiment of the disclosure.

FIG. 3 is a flowchart of processing by the travel controller according to the embodiment of the disclosure.

FIG. 4 is a block diagram of a configuration of a travel controller according to an embodiment of the disclosure.

FIG. 5 illustrates map data in which a level of alertness of a driver and an upper limit value of assistance torque are associated with each other, according to the embodiment of the disclosure.

FIG. 6 is a flowchart of processing by the travel controller according to the embodiment of the disclosure.

### DETAILED DESCRIPTION

In the technique described in JP-A No. H07-104850, whether to override is determined only by a value of the steering torque inputted by the driver.

Accordingly, constant steering torque is inputted regardless of presence or absence of the driver’s intention. When the inputted steering torque becomes larger than the predetermined threshold value, limitation processing is performed to limit the assistance torque to be applied to the steering mechanism.

However, in the technique described in JP-A No. H07-104850, for example, even when the driver inputs the steering torque to a steering wheel while dozing, the lane deviation prevention control is uniquely weakened. This results in a concern about possibility of lane deviation of the vehicle.

It is desirable to provide a travel controller that makes it possible to suppress limitation processing from being performed without intention of a driver in accordance with a level of alertness of the driver and a shape of a road on which the vehicle is traveling, and suppress lane deviation of the vehicle.

### Embodiments

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description.

### First Embodiment

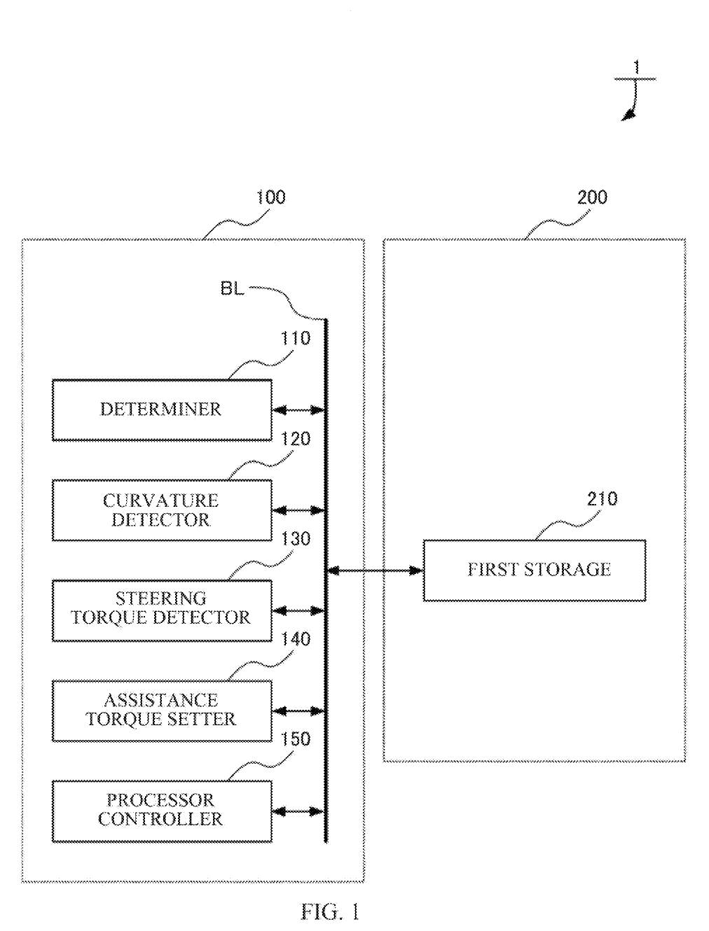

With reference to FIGS. 1 to 3, a travel controller 1 according to a first embodiment of the disclosure is described.

### Configuration of Travel Controller 1

As illustrated in FIG. 1, the travel controller 1 according to the embodiment may include a processor 100 and a memory 200.

As illustrated in FIG. 1, the travel controller 1 may include a determiner 110, a curvature detector 120, a steering torque detector 130, an assistance torque setter 140, a processor controller 150, and the memory 200. The determiner 110, the curvature detector 120, the steering torque detector 130, the assistance torque setter 140, and the processor controller 150 may constitute the processor 100. In one embodiment of the disclosure, the processor 100 may serve as a "processor." In one embodiment of the disclosure, the processor controller 150 may serve as a "controller."

The determiner 110 is configured to determine a level of alertness of a driver who drives a vehicle.

For example, the determiner 110 may determine the level of alertness of the driver based on a captured image of the driver from an imaging device.

The captured image may include a moving image and a still image. The determiner 110 may detect, for example, a posture of the driver when driving, how wide the eyes of the driver are opened, how many times the driver blinks the eyes, and the like obtained from the captured image of the driver from the imaging device, to determine the level of alertness of the driver.

In one alternative, the determiner 110 may acquire vital data regarding the driver, detect a degree of physical fatigue or a degree of mental fatigue, and determine the level of alertness of the driver comprehensively together with the captured image.

A determination result of the determiner 110 may be outputted to the processor controller 150 described later, through a bus line BL.

The curvature detector 120 is configured to detect a curvature of a lane traveled by the vehicle, from a captured image of a frontward view of the vehicle.

It is to be noted that a known method may be used as a method of detecting, based on the image, the curvature of the lane traveled by the vehicle and frontward of the vehicle.

A detection result of the curvature detector 120 may be outputted to the processor controller 150 described later, through the bus line BL.

The steering torque detector 130 is configured to detect steering torque given to a steering wheel of the vehicle by the driver.

The steering torque detector 130 may include, for example, a steering torque sensor. The steering torque detector 130 may output a signal corresponding to the steering torque given to the steering wheel. The steering wheel is configured to be turned by the driver.

A detection result of the steering torque detector 130 may be outputted to the processor controller 150 described later, through the bus line BL.

The assistance torque setter 140 is configured to calculate one or both of a controlled variable to return the vehicle toward the middle of the lane traveled by the vehicle and a controlled variable to avoid deviation of the vehicle from the middle of the lane traveled by the vehicle, and set assistance torque to be applied to a steering mechanism of the vehicle in accordance with the one or both of the controlled variables.

Non-limiting examples of a control to return the vehicle toward the middle of the lane traveled by the vehicle or a control to avoid the deviation of the vehicle from the middle of the lane traveled by the vehicle may include an automated lane keeping (ALK) control or a lane departure prevention (LDP) control.

A setting value of the assistance torque by the assistance torque setter 140 may be controlled by the processor controller 150 described later.

The processor controller 150 is configured to control processing by an entirety of the travel controller 1 based on a control program held in an unillustrated ROM (Read Only Memory) or the like.

For example, the processor controller 150 is configured to make a control to allow the assistance torque setter 140 to lower, or limit, the one or both of the controller variables for the assistance torque at least when the steering torque becomes larger than a first threshold value of the assistance torque, based on the steering torque detected by the steering torque detector 130 and map data held in a first storage 210 in the memory 200 described later. The first threshold value may be an upper limit value of the assistance torque.

The first threshold value may be varied by, for example, tuning and the like.

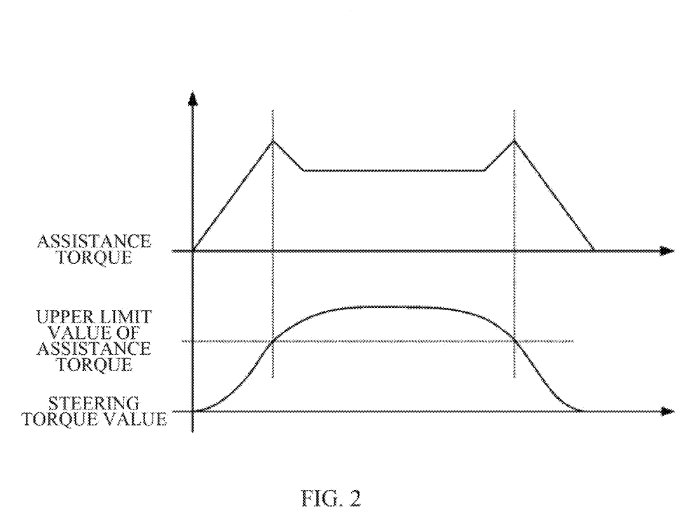

In the travel controller 1 of the embodiment, the assistance torque, the upper limit value of the assistance torque, and a steering torque value have relation as illustrated in FIG. 2.

That is, when the steering torque value becomes larger, the assistance torque also becomes larger. When the steering torque value becomes larger than the first threshold value, i.e., the upper limit value of the assistance torque, the assistance torque starts to become smaller, and thereafter, keeps a constant value.

When the steering torque value starts to become smaller, the assistance torque starts to become larger. When the steering torque value falls below the first threshold value, i.e., the upper limit value of the assistance torque, the assistance torque becomes smaller as the steering torque value becomes smaller.

As illustrated in FIG. 1, the memory 200 may include the first storage 210.

The first storage 210 may hold the map data in which the level of alertness of the driver, the curvature of the lane traveled by the vehicle, and the first threshold value, i.e., the upper limit value of the assistance torque, are associated with each other.

The first threshold value of the assistance torque, i.e., the upper limit value of the assistance torque, becomes larger as the level of alertness of the driver becomes lower. The first threshold value of the assistance torque, i.e., the upper limit value of the assistance torque, becomes larger as a curve of the lane traveled by the vehicle becomes sharper.

### Processing by Travel Controller 1

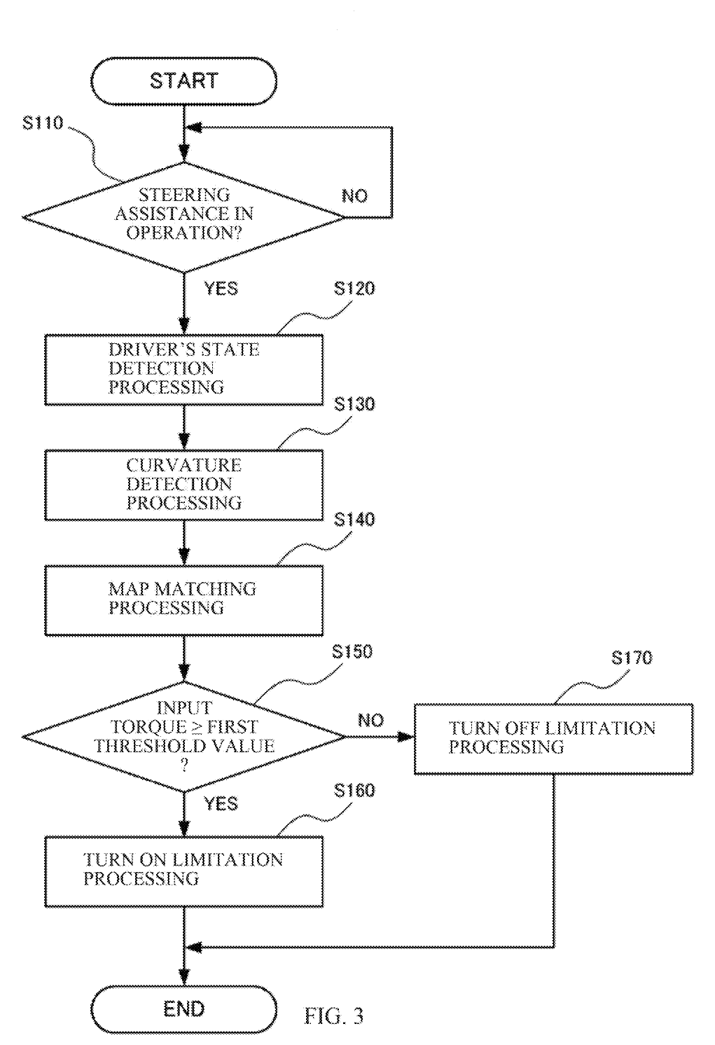

With reference to FIG. 3, processing by the travel controller 1 according to the embodiment is described.

First, the processor controller 150 may determine whether the steering assistance is in operation in the vehicle (step S110).

When the processor controller 150 determines that the steering assistance is not in operation in the vehicle ("NO" in step S110), the processor controller 150 may shift to a standby mode.

When the processor controller 150 determines that the steering assistance is in operation in the vehicle ("YES" in step S110), the processor controller 150 may detect the level of alertness of the driver based on determination processing of the level of alertness of the driver by the determiner 110 (step S120).

Thereafter, the processor controller 150 may bring the curvature detector 120 into operation to perform processing to detect the curvature of the lane traveled by the vehicle, from the captured image of the frontward view of the vehicle (step S130).

The processor controller 150 may bring the steering torque detector 130 into operation to perform processing to detect the steering torque given to the steering wheel by the driver, and perform map matching processing based on a processing result of the detection processing of the driver’s state in step S120, a processing result of the curvature detection processing in step S130, the steering torque value detected by the steering torque detector 130, and the map data held in the first storage 210 (step S140).

As a result of the map matching processing, the processor controller 150 may determine whether the steering torque value is equal to or larger than the predetermined first threshold value, i.e., the upper limit value of the assistance torque (step S150).

When the processor controller 150 determines that the steering torque value is equal to or larger than the predetermined first threshold value ("YES" in step S150), the processor controller 150 may make the control to allow the assistance torque setter 140 to lower, or limit, the one or both of the controlled variables for the assistance torque (step S160), and end the processing.

When the processor controller 150 determines that the steering torque value is not equal to or larger than the predetermined first threshold value ("NO" in step S150), the processor controller 150 may end the processing without making the control of the assistance torque setter 140 (step S170).

### Workings and Effects

As described above, the travel controller 1 according to the embodiment includes the determiner 110, the curvature detector 120, the steering torque detector 130, the assistance torque setter 140, the first storage 210, and the processor controller 150. The determiner 110 is configured to determine the level of alertness of the driver. The curvature detector 120 is configured to detect the curvature of the lane traveled by the vehicle, from the captured image of the frontward view of the vehicle. The steering torque detector 130 is configured to detect the steering torque given to the steering wheel by the driver. The assistance torque setter 140 is configured to calculate one or both of the controlled variable to return the vehicle to the middle of the lane traveled by the vehicle and the controlled variable to avoid the deviation of the vehicle from the middle of the lane traveled by the vehicle, and set the assistance torque to be applied to the steering mechanism in accordance with the one or both of the controlled variables. The first storage 210 is configured to hold the map data in which the level of alertness of the driver, the curvature, and the first threshold value of the assistance torque are associated with each other. The processor controller 150 is configured to limit the one or both of the controlled variables at least when the steering torque becomes larger than the first threshold value, and afterward, make the control to allow the assistance torque setter 140 to set the assistance torque.

That is, the processor controller 150 is configured to make the control to allow the assistance torque setter 140 to lower the value of the assistance torque to below the first threshold value, i.e., the upper limit value of the assistance torque, when the steering torque becomes larger than the first threshold value, i.e., the upper limit value of the assistance torque, based on the steering torque detected by the steering torque detector 130 and the map data held in the first storage 210 and in which the level of alertness of the driver, the curvature, and the first threshold value, i.e., the upper limit value of the assistance torque, are associated with each other.

As described above, by making a variable control of the value of the assistance torque, with the level of alertness of the driver and the curvature of the lane traveled by the vehicle serving as parameters, it is possible to continue the lane keeping control as much as possible when the level of alertness of the driver is low, without giving priority to the override.

In the map data of the travel controller 1 according to the embodiment, as the level of alertness of the driver becomes lower, and as the curvature becomes smaller, the first threshold value, i.e., the upper limit value of the assistance torque, becomes higher.

That is, by allowing the first threshold value, i.e., the upper limit value of the assistance torque to become higher as the level of alertness of the driver becomes lower, and as the curvature becomes smaller, it is possible to reduce the possibility that the limitation processing is started to limit an input of the steering torque to be applied to the steering mechanism, when the steering torque becomes larger than the first threshold value, i.e., the upper limit value of the assistance torque.

Hence, according to the configuration described above, it is possible to suppress the limitation processing from being performed without the intention of the driver in accordance with the level of alertness of the driver and the shape of the road traveled, and suppress the lane deviation of the vehicle.

### Second Embodiment

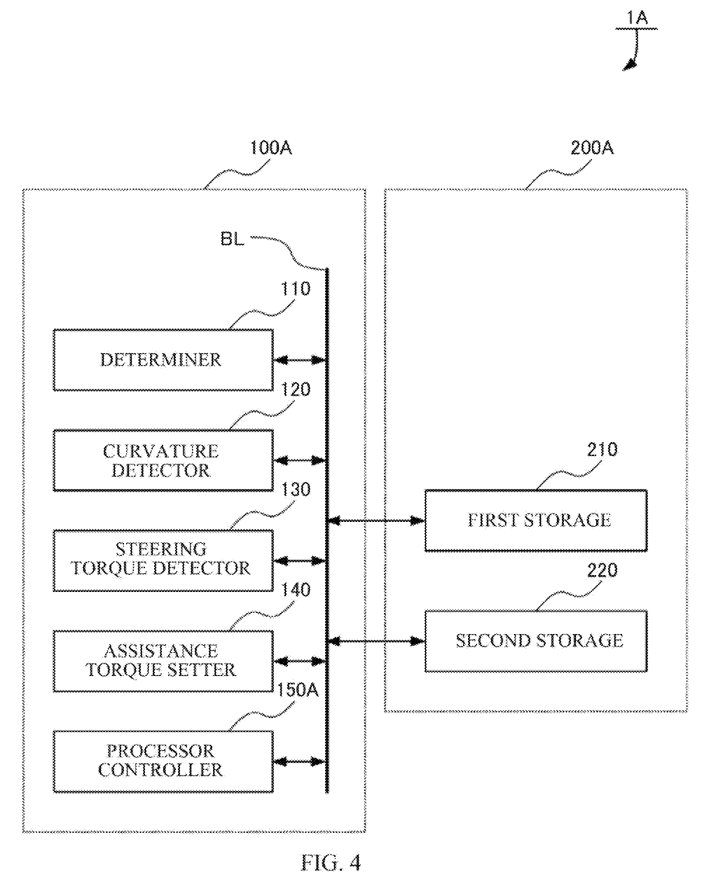

With reference to FIGS. 4 to 6, a travel controller 1A according to a second embodiment is described.

### Configuration of Travel Controller 1A

As illustrated in FIG. 4, the travel controller 1A according to the embodiment may include the determiner 110 the curvature detector 120, the steering torque detector 130, the assistance torque setter 140, a processor controller 150A, and the memory 200. The determiner 110, the curvature detector 120, the steering torque detector 130, the assistance torque setter 140, and the processor controller 150A may constitute a processor 100A. In one embodiment of the disclosure, the processor 100A may serve as the "processor." In one embodiment of the disclosure, the processor controller 150A may serve as the "controller."

The constituent elements denoted by the same reference characters as those in the first embodiment have similar configurations, and detailed description thereof is omitted.

The processor controller 150A is configured to control processing by an entirety of the travel controller 1A based on a control program held in an unillustrated ROM (Read Only Memory) or the like.

For example, when the steering torque becomes larger than a second threshold value, the processor controller 150A may cancel setting of the assistance torque by the assistance torque setter 140, based on map data held in a second storage 220 described later. The second threshold value is provided for cancellation of the setting of the assistance torque by the assistance torque setter 140.

As illustrated in FIG. 4, the memory 200 may include the first storage 210 and the second storage 220.

The second storage 220 may hold the map data in which the level of alertness of the driver and the second threshold value are associated with each other. The second threshold value is provided for the cancellation of the setting of the assistance torque by the assistance torque setter 140.

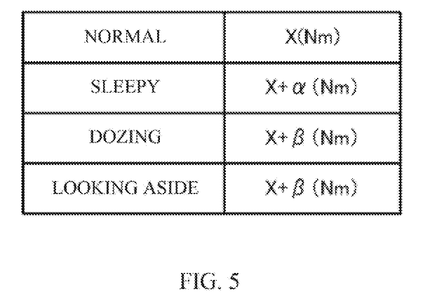

FIG. 5 illustrates an example of the map data.

As illustrated in FIG. 5, the map data may be, for example, map data in which the level of alertness of the driver and the second threshold value for the cancellation of the setting of the assistance torque are associated with each other.

The level of alertness of the driver may be classified into, for example, "normal," "sleepy," "dozing," "looking aside," and the like, with each of which the second threshold value for the cancellation of the setting of the assistance torque is associated.

As summarized in FIG. 5, as the level of alertness of the driver changes from "normal" to "sleepy," or from "sleepy" to "dozing" or "looking aside," the second threshold value for the cancellation of the setting of the assistance torque may take a large value.

In one example, as illustrated in FIG. 5, for example, let us assume the second threshold value for "normal" to be "X (Nm)." When the level of alertness changes from "normal" to "sleepy," the second threshold value may become "X+α (Nm)." When the level of alertness changes from "sleepy" to "dozing" or "looking aside," the second threshold value may become "X+β (Nm)."

Because α and β satisfy α<β, as the level of alertness changes from "normal" to "sleepy," or from "sleepy" to "dozing" or "looking aside," the second threshold value for the cancellation of the setting of the assistance torque may take a larger value.

### Processing by Travel Controller 1A

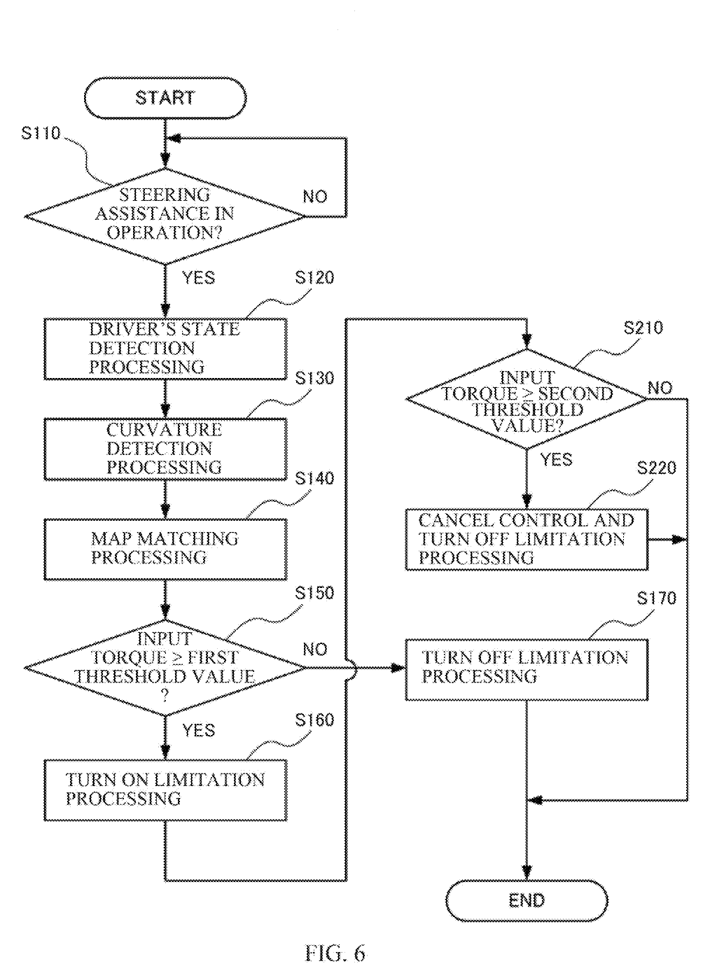

With reference to FIG. 6, processing by the travel controller 1A according to the embodiment is described.

First, the processor controller 150A may determine whether the steering assistance is in operation in the vehicle (step S110).

When the processor controller 150A determines that the steering assistance is not in operation in the vehicle ("NO" in step S110), the processor controller 150A may shift to the standby mode.

When the processor controller 150A determines that the steering assistance is in operation in the vehicle ("YES" in step S110), the processor controller 150A may detect the driver’s state based on the determination processing of the level of alertness of the driver by the determiner 110 (step S120).

Thereafter, the processor controller 150A may bring the curvature detector 120 into operation to perform the processing to detect the curvature of the lane traveled by the vehicle, from the captured image of the frontward view of the vehicle (step S130).

The processor controller 150A may bring the steering torque detector 130 into operation to perform the processing to detect the steering torque given to the steering wheel by the driver, and perform the map matching processing based on the processing result of the detection processing of the driver’s state in step S120, the processing result of the curvature detection processing in step S130, the steering torque value detected by the steering torque detector 130, and the map data held in the first storage 210 (step S140).

As a result of the map matching processing, the processor controller 150A may determine whether the steering torque value is equal to or larger than the predetermined first threshold value, i.e., the upper limit value of the assistance torque (step S150).

When the processor controller 150A determines that the steering torque value is not equal to or larger than the predetermined first threshold value ("NO" in step S150), the processor controller 150A may end the processing without making the control of the assist torque setter 140 (step S170).

When the processor controller 150A determines that the steering torque value is equal to or larger than the predetermined first threshold value ("YES" in step S150), the processor controller 150A may make the control to allow the assistance torque setter 140 to lower the value of the assistance torque to below the upper limit value of the assistance torque (step S160).

Thereafter, the processor controller 150A may determine whether the steering torque value is equal to or larger than the predetermined second threshold value, i.e., the upper limit value for the cancellation of the setting of the assistance torque (step S210).

When processor controller 150A determines that the steering torque value is not equal to or larger than the predetermined second threshold value, i.e., the upper limit value for the cancellation of the setting of the assistance torque ("No" in step S210), the processor controller 150A may end the processing.

When processor controller 150A determines that the steering torque value is equal to or larger than the predetermined second threshold value, i.e., the upper limit value for the cancellation of the setting of the assistance torque ("YES" in step S210), the processor controller 150A may turn off the limitation processing and end the processing related to the steering assistance.

### Workings and Effects

As described above, the travel controller 1A according to the embodiment may include the second storage 220. The second storage 220 is configured to hold the map data in which the level of alertness of the driver and the upper limit value for the cancellation of the setting of the assistance torque by the assistance torque setter 140, i.e., the second threshold value, are associated with each other. When the steering torque becomes larger than the upper limit value for the cancellation of the setting of the assistance torque by the assistance torque setter 140, i.e., the second threshold value, the processor controller 150A is configured to cancel the setting of the assistance torque by the assistance torque setter 140, based on the map data held in the second storage 220.

That is, when the steering torque becomes larger than the upper limit value for the cancellation of the setting of the assistance torque by the assistance torque setter 140, i.e., the second threshold value, the processor controller 150A is configured to cancel the setting of the assistance torque by the assistance torque setter 140, based on the map data held in the second storage 220.

As described above, by making the variable control of the value of the assistance torque, with the level of alertness of the driver and the curvature of the lane traveled by the driver serving as the parameters, it is possible to continue the lane keeping control as much as possible when the level of alertness of the driver is low, without giving priority to the override.

Thus, according to the configuration described above, when the level of alertness of the driver is low, it is possible to suppress the deviation unintended by the driver from the lane, or the middle of the lane traveled by the vehicle.

In addition, by making the variable control of the value of the assistance torque, with the level of alertness of the driver and the curvature of the lane traveled by the vehicle serving as the parameters, and when the steering torque becomes larger than the upper limit value for the cancellation of the setting of the assistance torque by the assistance torque setter 140, i.e., the second threshold value, cancelling the setting of the assistance torque by the assistance torque setter 140 based on the map data held in the second storage 220, it is possible to continue a steering assistance control when the driver is in an abnormal state.

In some embodiments, it is possible to implement the travel controllers 1 and 1A of the example embodiments of the disclosure by recording the processing to be carried out by the processor controllers 150 and 150A on a non-transitory recording medium readable by a computer system, and allowing the processor controllers 150 and 150A to read and execute the program recorded on the non-transitory recording medium. The computer system as used herein may encompass an operating system (OS) and hardware such as peripheral devices.

In addition, when the computer system utilizes a WWW (World Wide Web) system, the "computer system" may encompass a website providing environment or a website displaying environment. The program may be transmitted from a computer system that contains the program in a storage device or the like to another computer system via a transmission medium or by a carrier wave in a transmission medium. The "transmission medium" that transmits the program may refer to a medium configured to transmit data, including a network (e.g., a communication network) such as the Internet and a communication link (e.g., a communication line) such as a telephone line.

Further, the program may be directed to implement a part of the processing described above. The program may be a so-called differential file (differential program) configured to implement the processing by a combination with a program already held in the computer system.

Although some example embodiments of the disclosure have been described in the foregoing by way of example with reference to the accompanying drawings, the disclosure is by no means limited to the embodiments described above. The technical scope of the disclosure encompasses any travel controller to be thought of by persons skilled in the art by appropriate design changes based on the travel controllers 1 and 1A described above as the embodiments of the disclosure, as long as the travel controller includes the gist of the disclosure.

It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, the technical scope of the disclosure encompasses whatever is obtained by persons skilled in the art by appropriately adding or eliminating constituent elements to or from the forgoing embodiments, making design changes of the forgoing embodiments, adding or eliminating processes to or from the forgoing embodiments, or making changes in conditions of processes, as long as they include the gist of the disclosure.

It should be appreciated that the disclosure encompasses any other workings and effects to be produced from the forgoing embodiments of the disclosure as long as they are clear in view of the description in the specification or they are conceivable as appropriate to persons skilled in the art.

Various inventions may be made by appropriately combining constituent elements disclosed in the forgoing embodiments.

For example, some constituent elements may be eliminated from the constituent elements described in the forgoing embodiments.

Moreover, constituent elements from different embodiments may be appropriately combined.

The processors 100 and 100A illustrated in FIGS. 1 and 4 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processors 100 and 100A. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processors 100 and 100A illustrated in FIGS. 1 and 4.

1. A travel controller configured to be applied to a vehicle, the travel controller comprising:
a determiner configured to determine a level of alertness of a driver who drives the vehicle;
a curvature detector configured to detect a curvature of a lane traveled by the vehicle, from a captured image of a frontward view of the vehicle;
a steering torque detector configured to detect steering torque given to a steering wheel of the vehicle by the driver;
an assistance torque setter configured to calculate one or both of a first controlled variable to return the vehicle toward a middle of the lane traveled by the vehicle and a second controlled variable to avoid deviation of the vehicle from the middle of the lane traveled by the vehicle, and set assistance torque to be applied to a steering mechanism of the vehicle in accordance with the one or both of the first controlled variable and the second controlled variable;
a first storage configured to hold map data in which the level of alertness of the driver, the curvature, and a first threshold value of the assistance torque are associated with each other; and
a controller configured to limit the one or both of the first controlled variable and the second controlled variable at least when the steering torque becomes larger than the first threshold value, and afterward, make a control to allow the assistance torque setter to set the assistance torque.

2. The travel controller according to claim 1, wherein
in the map data, as the level of alertness of the driver becomes lower, and as the curvature becomes smaller, the first threshold value of the assistance torque becomes higher.

3. The travel controller according to claim 1, further comprising
a second storage configured to hold map data in which the level of alertness of the driver and a second threshold value of the assistance torque are associated with each other, the second threshold value being provided for cancellation of setting of the assistance torque by the assistance torque setter, wherein
the controller is configured to, based on the map data held in the second storage, cancel a lane keeping control, when the steering torque becomes larger than the second threshold value of the assistance torque, the lane keeping control comprising one or both of an automated lane keeping control and a lane departure prevention control.

4. A travel controller configured to be applied to a vehicle, the travel controller comprising one or more processors and one or more memories communicably coupled to the one or more processors,
the one or more processors being configured to:
determine a level of alertness of a driver who drives the vehicle;
detect a curvature of a lane traveled by the vehicle, from a captured image of a frontward view of the vehicle;
detect steering torque given to a steering wheel of the vehicle by the driver;
calculate one or both of a first controlled variable to return the vehicle toward a middle of the lane traveled by the vehicle and a second controlled variable to avoid deviation of the vehicle from the middle of the lane traveled by the vehicle, and set assistance torque to be applied to a steering mechanism of the vehicle in accordance with the one or both of the first controlled variable and the second controlled variable; and
limit the one or both of the first controlled variable and the second controlled variable at least when the steering torque becomes larger than a first threshold value of the assistance torque, and afterward, make a control to set the assistance torque, and
the one or more memories being configured to hold map data in which the level of alertness of the driver, the curvature, and the first threshold value are associated with each other.
